(19) United States
(12) Patent Application Publication
(10) Pub. No.: US 2026/0102944 A1
(43) Pub. Date: Apr. 16, 2026

(54) INTERNAL MIXER

(71) Applicant: KABUSHIKI KAISHA KOBE SEIKO SHO (KOBE STEEL, LTD.), Hyogo (JP)

(72) Inventors: Hodaka MIURA, Takasago-shi (JP); Hiroomi KATANO, Takasago-shi (JP); Martin C. GREEN, Billerica, MA (US)

(73) Assignee: KABUSHIKI KAISHA KOBE SEIKO SHO (KOBE STEEL, LTD.), Hyogo (JP)

(21) Appl. No.: 19/347,432

(22) Filed: Oct. 1, 2025

Related U.S. Application Data
(60) Provisional application No. 63/707,506, filed on Oct. 15, 2024.

(51) Int. Cl. B29B 7/20; B29B 7/18; B29B 7/24

(52) U.S. Cl. CPC B29B 7/20; B29B 7/183; B29B 7/246

(57) ABSTRACT

An internal mixer includes a mixing chamber having a mixing room, a material input portion located above the mixing chamber, a weight, a driving device that raises and lowers the weight between a lower position where the weight can press a material to be kneaded in the mixing room from above and a retraction position where the weight is retracted upward from the lower position, a mixing rotor that kneads the material to be kneaded in the mixing room, and an exhausting device having an inner end portion facing the mixing room and provided in the mixing chamber and configured to be able to discharge gas generated during kneading of the material to be kneaded from the inner end to the outside of the mixing chamber.

### FIELD OF INVENTION

The present invention relates to an internal mixer.

### BACKGROUND ART

As disclosed in Japanese Patent Application Laid-Open No. Hei 10-217240, Japanese Patent Application Laid-Open No. 2016-43520, Japanese Patent Application Laid-Open No. Hei 7-232320, Japanese Patent Application Laid-Open No. 2013-107025, and Japanese Patent Application Laid-Open No. 2007-118387, there has been conventionally known an internal mixer including a mixing chamber having a mixing room with an open upper portion, and a weight disposed so as to be movable up and down to the mixing room, the internal mixer kneading a material to be kneaded while pressing the material to be kneaded from above by the weight in the mixing room. The kneaders disclosed in Japanese Patent Application Laid-Open No. Hei 10-217240, Japanese Patent Application Laid-Open No. 2016-43520, and Japanese Patent Application Laid-Open No. Hei 7-232320 are used in a kneading method of feeding oil and kneading raw material rubber. A kneader disclosed in Japanese Patent Application Laid-Open No. 2013-107025 is used in a kneading method in which a kneading material such as rubber or plastic and a powder blending agent are fed together in a mixing room to knead a material to be kneaded. The kneader disclosed in Japanese Patent Application Laid-Open No. 2013-107025 is provided with a ventilation chute connected to a mixing chamber, and the ventilation chute is provided with an airbag having a filter body. As a result, the dust-containing gas accompanied with the powder blending agent can be prevented from scattering to the outside. The kneader disclosed in Japanese Patent Application Laid-Open No. 2007-118387 is configured to lower the particulate concentration in the mixing room by introducing an inert gas into the mixing room.

In a kneader in which a material to be kneaded is kneaded in a state in which a weight lowers so as to close an upper opening of a mixing room, for example, when a material to be kneaded containing a large amount of moisture is kneaded, the moisture vaporizes as the temperature during kneading rises, and the internal pressure in the mixing room may rise. In addition, there may be a case where the gas escapes from the gap portion between the edge of the upper opening in the mixing room and the weight, but even in this case, in a case where a large amount of moisture is vaporized, the pressure in the mixing room may increase. In addition, the kneading material and the additive may be clogged in the gap portion, and in this case, degassing cannot be performed.

### SUMMARY OF THE INVENTION

An object of the present invention is to provide an internal mixer suitable for kneading a material to be kneaded in which a large amount of gas such as steam is generated.

An internal mixer according to an aspect of the present invention includes: a mixing chamber having a mixing room with an upper opening; a material input portion located above the mixing chamber, having an inner space communicating with the mixing room, and configured to be able to feed a material of a material to be kneaded into the inner space; a weight provided in the inner space; a driving device configured to move the weight up and down between a lower position and a retraction position, the lower position being a position where the weight enters the mixing chamber and is capable of pressing the material to be kneaded in the mixing room from above, and the retraction position being a position where the weight retreats from the lower position to open the mixing room; a pair of mixing rotors configured to knead the material to be kneaded in the mixing room; and an exhausting device having an inner end portion facing the mixing room and provided in the mixing chamber, the exhausting device being configured to discharge gas generated during kneading of the material to be kneaded from the inner end portion to an outside of the mixing chamber.

### BRIEF DESCRIPTION OF THE DRAWINGS

FIG. 1 is a cross-sectional view of an internal mixer according to the present embodiment as viewed from the side.

FIG. 2 is a cross-sectional view of the internal mixer according to the present embodiment as viewed from above a mixing chamber.

FIG. 3 is a diagram illustrating an exhausting device provided in the internal mixer and illustrating a state in which a rod is at a closed position.

FIG. 4 is a diagram illustrating the exhausting device provided in the internal mixer and illustrating a state in which the rod is at an open position.

FIG. 5 is a diagram illustrating an exhausting device provided in an internal mixer according to a first modification.

FIG. 6 is a diagram illustrating an exhausting device provided in an internal mixer according to a second modification.

### DETAILED DESCRIPTION

Embodiments of the present invention will hereinafter be described in detail with reference to the drawings.

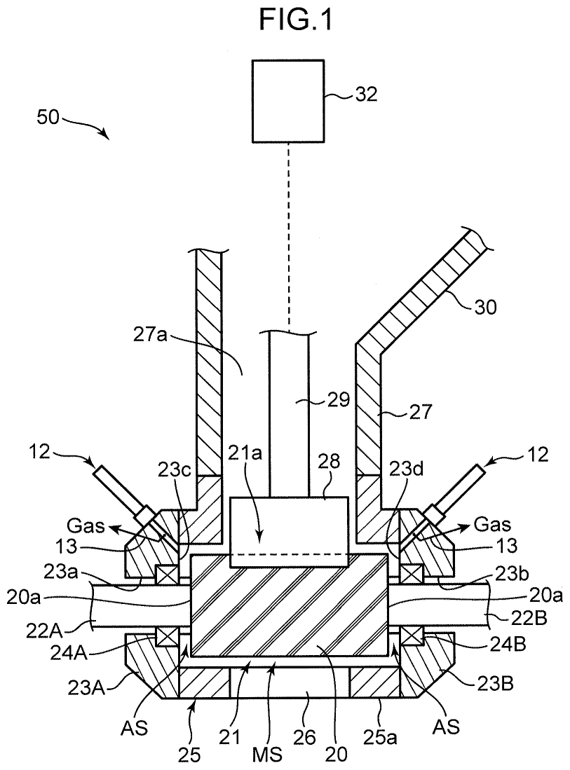

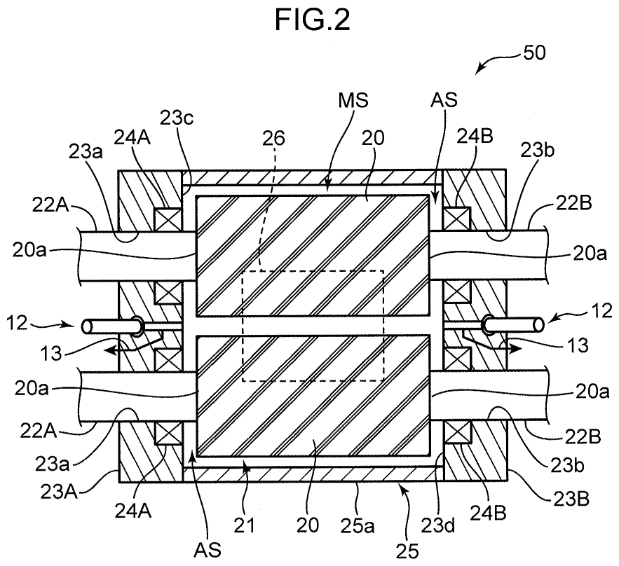

As illustrated in FIGS. 1 and 2, an internal mixer 50 according to the present embodiment is an apparatus for kneading a material to be kneaded such as rubber or resin. The kneader 50 includes a mixing chamber 25 having a mixing room 21 with an upper opening 21a, a material input portion 27 located above the mixing chamber 25, and a weight 28 disposed in the material input portion 27.

The mixing room 21 is a room for kneading a material to be kneaded. A pair of mixing rotors 20 is disposed in the mixing room 21. The pair of mixing rotors 20 is rotatably disposed in parallel to each other in the mixing room 21. Rotor shafts 22A and 22B extend from both sides of each mixing rotor 20 in the axial direction. The rotor shafts 22A and 22B penetrate endplates 23A and 23B described later of the mixing chamber 25, and are driven and rotated by a motor (not illustrated) disposed outside the mixing chamber 25. The pair of mixing rotors 20 is driven to knead the material to be kneaded in the mixing room 21.

The material input portion 27 has an inner space 27a communicating with the mixing room 21. The material input portion 27 is provided with a hopper 30 through which the material of the material to be kneaded can be fed into the inner space 27a of the material input portion 27.

The weight 28 is provided so as to be movable up and down in the inner space 27a of the material input portion 27. The weight 28 is connected to a driving device 32 for raising and lowering the weight 28 via a connecting rod 29. The driving device 32 moves up and down the weight 28 between the lower position and the retraction position. The driving device 32 may include, for example, a cylinder (not illustrated) and a piston (not illustrated) slidably disposed in the cylinder, and may be configured to move the weight 28 in the vertical direction via the connecting rod 29 by reciprocating movement of the piston. The driving device 32 applies a downward force to the weight 28 so that the weight 28 can press the material to be kneaded.

When the weight 28 is at the lower position, the weight 28 enters the upper opening 21a of the mixing room 21. The weight 28 thus can press the material to be kneaded in the mixing room 21 from above. When the weight 28 is at the lower position, the upper opening 21a of the mixing room 21 is substantially closed by the weight 28. At this time, a gap is generated between the inner peripheral portion defining the upper opening 21a in the mixing chamber 25 and the peripheral edge of the weight 28 located at the lower position. Therefore, in a case where the internal pressure of the mixing room 21 increases, the air (in some cases, it may also include the fed powdery material) in the mixing room 21 may leak into the inner space 27a of the material input portion 27 through the gap.

The retraction position is a position where the weight 28 is raised from the lower position, and when the weight 28 is at the retraction position, the upper opening 21a of the mixing room 21 is opened to the inner space 27a of the material input portion 27. The weight 28 can be raised to a position above the connection portion of the hopper 30 in the material input portion 27.

The mixing chamber 25 includes a cylindrical chamber body 25a and a pair of endplates 23A and 23B that closes openings at both ends of the chamber body 25a. The chamber body 25a is formed in a cylindrical shape surrounding the pair of mixing rotors 20, and an upper opening 21a that allows the mixing room 21 and the inner space 27a of the material input portion 27 to communicate with each other is formed in an upper portion of the chamber body 25a. An exhaust port 26 for discharging the material to be kneaded is provided in a lower portion of the chamber body 25a. The exhaust port 26 is closed when the material to be kneaded is kneaded, and is opened by a discharge command.

The chamber body 25a is formed in a cylindrical shape in which both ends in the extending direction of the rotor shafts 22A and 22B of the mixing rotor 20 are opened. The endplates 23A and 23B are coupled to the end surfaces of the chamber body 25a from the outside in the extending direction of the rotor shafts 22A and 22B so as to close the openings at both ends of the chamber body 25a. The endplates 23A and 23B are provided with through holes 23a and 23b through which the rotor shafts 22A and 22B are inserted, and the endplates 23A and 23B are provided with bearings 24A and 24B that rotatably support the rotor shafts 22A and 22B.

The length of the chamber body 25a is longer than the length of the mixing rotor 20 in the extending direction of the rotor shafts 22A and 22B (or the left-right direction in FIGS. 1 and 2). Thus, an end surface 20a of the mixing rotor 20 in the extending direction of the rotor shafts 22A and 22B and inner surfaces 23c and 23d of the endplates 23A and 23B are separated from each other. That is, a space is also formed between the end surface 20a of the mixing rotor 20 and the inner surfaces 23c and 23d of the endplates 23A and 23B.

The space in the mixing room 21 includes a mixing area MS at a position corresponding to the mixing rotor 20 and an adjacent area AS at a position shifted from the mixing area MS in the extending direction of the rotor shafts 22A and 22B. The adjacent area AS is adjacent to the mixing area MS.

The mixing area MS is a space located between the end surfaces 20a and 20a of the mixing rotor 20 in the direction in which the rotor shafts 22A and 22B extend when viewed in the direction orthogonal to the rotor shafts 22A and 22B (as viewed in the direction perpendicular to the paper plane of FIG. 1). At the time of kneading, the material to be kneaded is kneaded mainly in the mixing area MS in the mixing room 21. The mixing area MS includes a space above the pair of mixing rotors 20, a space below the same, a space on the right side the same, and a space on the left side the same.

The adjacent area AS is a space located outside the end surface 20a of the mixing rotor 20 in the extending direction of the rotor shafts 22A and 22B. The adjacent area AS includes an facing space facing the end surfaces 20a of the pair of mixing rotors 20 and an annular outer peripheral space located on the outer circumference of the facing space. The facing space is a space between the end surface 20a of the mixing rotor 20 and the inner surfaces 23c and 23d of the endplates 23A and 23B facing toward the end surface 20a.

The mixing chamber 25 is provided with an exhausting device 12 configured to discharge gas generated during kneading of the material to be kneaded from the mixing room 21. The exhausting device 12 has an inner end 12a facing in the mixing room 21, and is configured to discharge the gas in the mixing room 21 to the outside of the mixing room 21 from the inner end 12a.

That is, at the time of kneading the material to be kneaded, a gas (including evaporation of moisture or the like) may be generated from the material to be kneaded. This gas escapes from the mixing room 21 into the inner space 27a of the material input portion 27 through the gap around the weight 28. Therefore, if the amount of gas generated at the time of kneading is not large, the internal pressure of the mixing room 21 does not increase so much. However, when the material to be kneaded containing a large amount of evaporation is kneaded, the amount of gas generated is large, and the internal pressure in the mixing room 21 may increase. Therefore, the exhausting device 12 is provided to discharge the gas from the mixing room 21 other than the gap around the weight 28 to suppress an increase in pressure in the mixing room 21.

In the present embodiment, the exhausting device 12 is provided in each of the pair of endplates 23A and 23B. Therefore, the inner ends 12a of the exhausting devices 12 are positioned on the inner surfaces 23c and 23d of the endplates 23A and 23B and face the adjacent area AS. During kneading, the material to be kneaded flows in the mixing area MS as the mixing rotor 20 is driven. Therefore, even if the exhausting device 12 for discharging gas from the mixing room 21 is provided such that the inner end 12a is located in the adjacent area AS, the possibility that the material to be kneaded contacts the inner end 12a of the exhausting device 12 can be reduced.

In the present embodiment, the inner end 12a of the exhausting device 12 is located in a space located above the pair of mixing rotors 20 in the outer peripheral space included in the adjacent area AS. That is, as illustrated in FIG. 1, the inner end 12a of the exhausting device 12 is located above the upper end of the mixing rotor 20 in the outer peripheral space (adjacent area AS). This can further reduce the possibility that the material to be kneaded comes into contact with the inner end 12a of the exhausting device 12. The inner end 12a of the exhausting device 12 is not necessarily located above the mixing rotor 20, but may be located above the rotor shafts 22A and 22B in the adjacent area AS, or may be located below the rotor shafts 22A and 22B in the adjacent area AS.

In the present embodiment, as illustrated in FIG. 2, the inner end 12a of the exhausting device 12 is located at an intermediate portion between the pair of rotor shafts 22A and 22A and an intermediate portion between the pair of rotor shafts 22B and 22B when viewed from above. However, the exhausting device 12 does not need to be disposed at this position, and may be disposed at a position different from this position.

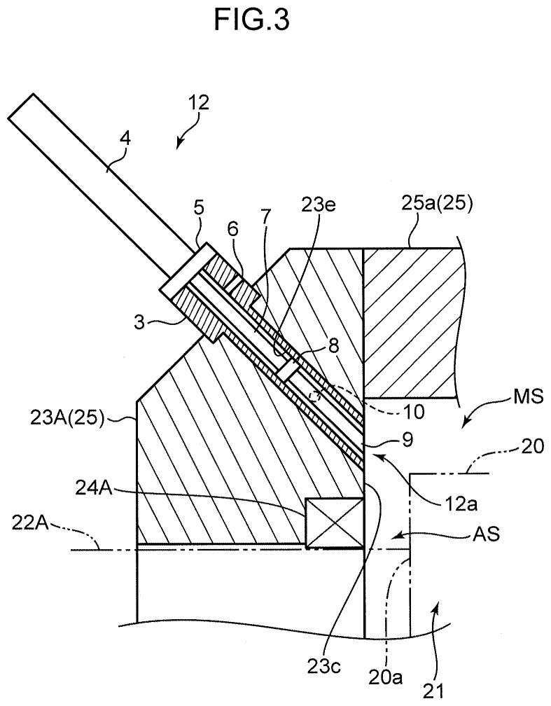

As illustrated in FIG. 3, the exhausting device 12 includes a cylindrical rod guide 3 inserted into a through hole 23e formed in each of the endplates 23A and 23B, a degassing port 10 provided in the rod guide 3, and an exhaust passage 13 (see FIGS. 1 and 2) provided in each of the endplates 23A and 23B so as to communicate with the degassing port 10. The exhaust passage 13 allows the degassing port 10 and the outer surfaces of the endplates 23A and 23B (the outer surface of the mixing chamber 25) to communicate with each other.

The through hole 23e into which the rod guide 3 is inserted penetrates the endplates 23A and 23B between the inner surfaces 23c and 23d of the endplates 23A and 23B and the outer surfaces of the endplates 23A and 23B. The rod guide 3 is disposed in the through hole 23e so as to open on the inner surfaces 23c and 23d of the endplates 23A and 23B. Therefore, the gas in the mixing room 21 can be discharged to the outside of the mixing chamber 25 through the space in the rod guide 3, the degassing port 10, and the exhaust passage 13. In this case, the inner end portion (that is, an inner opening 9) of the rod guide 3 functions as the inner end 12a of the exhausting device 12 that opens to the mixing room 21.

The exhaust passage 13 and the degassing port 10 may be used to blow air from the outside of the mixing chamber 25. By blowing air from the outside, clogging in the rod guide 3 can be removed.

The exhausting device 12 further includes a rod 7 disposed in the rod guide 3 and a cylinder 4 for moving the rod 7. The rod 7 is disposed so as to extend outward from the inside of the cylinder 4. The cylinder 4 is attached to the outer end (base end) of the rod guide 3 via a bracket 5. An inner surface of the rod guide 3 and an outer surface of the rod 7 define a gap therebetween to allow the rod 7 to easily move.

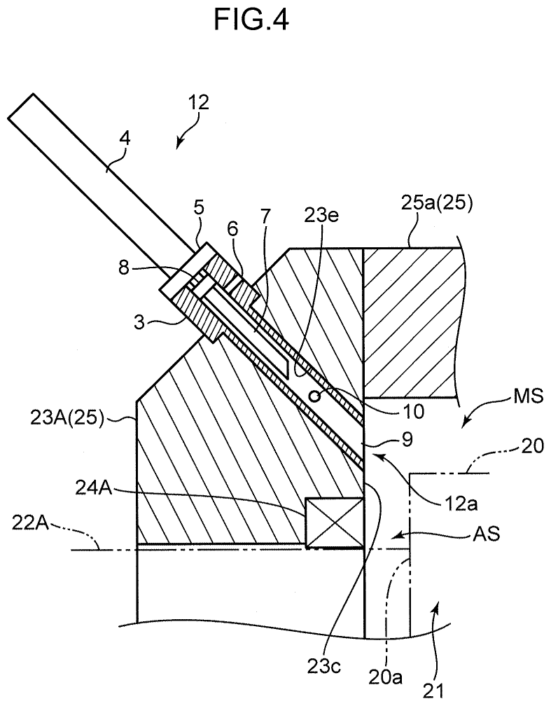

The cylinder 4 is configured to move the rod 7 forward and backward so that the degassing port 10 is opened and closed by the rod 7. That is, the cylinder 4 slides the rod 7 between a closed position (position illustrated in FIG. 3) where the distal end of the rod 7 (end on the mixing room 21 side) is located on the mixing room 21 side with respect to the degassing port 10 and an open position (position illustrated in FIG. 4) where the distal end of the rod 7 is located on the opposite side of the mixing room 21 with respect to the degassing port 10. The cylinder 4 operates by receiving hydraulic pressure or the like, but is not limited thereto.

In a case where the rod 7 is at the closed position, the degassing port 10 is covered with the rod 7 in a state where the gap exists between the rod guide 3 provided with the degassing port 10 and the rod 7 as illustrated in FIG. 3. Therefore, degassing in the mixing room 21 can be performed while the amount of gas escaping from the mixing room 21 is relatively restricted in comparison with a case where the rod 7 is at the open position as illustrated in FIG. 4. In this case, the distal end of the rod 7 may substantially close the inner end portion (that is, the inner opening 9) of the rod guide 3. Thus, the amount of gas for the degassing is further restricted, but the material to be kneaded in the mixing room 21 can be prevented from entering the rod guide 3. At this time, the distal end surface of the rod 7 may be aligned with the inner surfaces 23c and 23d of the endplates 23A and 23B (or inner surfaces of the mixing chamber 25). In other words, the distal end surface of the rod 7 and the inner surfaces 23c and 23d of the endplates 23A and 23B (or inner surfaces of the mixing chamber 25) may be located on the same surface. When the distal end of the rod 7 is movable to a position where the distal end does not protrude from the inner surfaces 23c and 23d of the endplates 23A and 23B (or the inner surfaces of the mixing chamber 25), the distal end of the rod 7 can be prevented from interfering with the kneading.

In a case where the rod 7 is at the open position, the degassing port 10 is opened by the rod 7 as illustrated in FIG. 4. In this case, degassing in the mixing room 21 is more actively performed than in the case where the rod 7 is at the closed position. The material to be kneaded in the mixing room 21 may enter the rod guide 3 in the case where the rod 7 is at the opening position. However, the material to be kneaded having entered would be pushed back into the mixing room 21 by the rod 7 when the rod 7 moves to the closed position. This can prevent the material to be kneaded having entered from impeding an opening/closing motion of the rod 7.

A degassing pipe (not illustrated) is connected to the exhaust passage 13. The degassing pipe is connected to a scraper (not illustrated) or the like, and contaminants are removed. Therefore, the gas discharged from the mixing room 21 is released to the atmosphere in a purified and cooled state. The degassing pipe may be provided with an opening/closing mechanism, and in this case, degassing on/off may be controlled by an opening/closing operation of the opening/closing mechanism.

The cylinder 4 is actuated by a command from a controller (not illustrated) to drive the rod 7. Accordingly, the degassing port 10 can be opened when the gas in the mixing room 21 is discharged or when air is blown from the outside. When no command is received from the controller, the cylinder 4 may position the rod 7 at a closed position where the degassing port 10 is covered with the rod 7. In addition, the controller may drive the rod 7 so that the rod 7 repeats the forward and backward movement between the open position and the closed position every predetermined time. As a result, the kneading material entering the rod guide 3 can be pushed out to the mixing room 21. The controller may control driving of the two rods 7 such that the rod 7 of one exhausting device 12 opens the degassing port 10 and the rod 7 of the other exhausting device 12 covers the degassing port 10. Then, the controller may control the driving of the two rods 7 so as to repeat alternately. Accordingly, it is possible to continuously discharge air from the mixing room 21 while preventing clogging of the kneading material in the rod guide 3.

In a case where a powdery material is mixed with the material to be kneaded, it may be necessary to discharge gas while preventing the powdery material from being discharged. In such a case, the timing of actuating the cylinder 4 may be controlled so as to move the rod 7 to the open position after the kneading is performed for a predetermined time.

In this case, for example, a timer that starts the time after the kneading is started is provided, and the controller may position the rod 7 in the closed position until the measured time reaches a preset time, and position the rod 7 in the open position where the degassing port 10 is exposed when the measured time reaches the preset time. Alternatively, a detector for detecting the temperature of the mixing chamber 1 may be provided and the controller may position the rod 7 in the closed position until the temperature detected by this detector reaches a preset temperature, and position the rod 7 at the open position where the degassing port 10 is exposed when the detected temperature reaches the preset temperature. Alternatively, a linear sensor that monitors the position of the weight 28 may be provided, and the controller may perform control to position the rod 7 at the closed position until the position of the weight 28 is lowered to the reference position, and open the degassing port 10 when it is detected that the position of the weight 28 is lowered to the reference position. In addition, when the temperature detected by the temperature detector attached to the exhaust port 26 reaches a preset temperature, control to expose the degassing port 10 may be performed. In addition, a detector that detects the power (or the current value or the voltage value) of the motor that drives the rotor shafts 22A and 22B may be provided, and when it is detected that the value detected by the detector starts to decrease beyond the peak, control to expose the degassing port 10 may be performed.

The through hole 23e in which the rod guide 3 is disposed is formed to extend in an oblique direction. That is, the through hole 23e extends obliquely upward from an end portion opened to the inner surfaces 23c and 23d of the endplates 23A and 23B or from the inner opening 9. This facilitates attachment of the rod guide 3 and attachment of the cylinder 4 to the rod guide 3. In addition, it is possible to prevent the material to be kneaded from entering the rod guide 3. In addition, lubricating oil injected from an injection port 6 described later can be easily spread to the inner surface of the rod guide 3.

Since the rod 7 and the rod guide 3 are obliquely arranged, the distal end of the rod 7 is obliquely cut. As a result, the distal end surface of the rod 7 easily conforms with the inner surfaces 23c and 23d of the endplates 23A and 23B.

A boss 8 is provided in an intermediate portion of the rod 7. The boss 8 is a portion having a diameter larger than a diameter of the rod 7 and is in contact with the inner surface of the rod guide 3. The rod guide 3 is provided with the injection port 6 at a position closer to the cylinder 4 than the degassing port 10. The injection port 6 can be used to inject liquid into the rod guide 3. Examples of the liquid include a lubricating oil for rod lubrication, a process oil for mixing with a material to be kneaded to change characteristics of the material to be kneaded, and a liquid for pushing out the material to be kneaded and by-products clogged in the rod guide 3 into the mixing room 21.

The cylinder 4 moves the rod 7 so that the boss 8 can selectively take a state of being located closer to the mixing room 21 than the injection port 6 (state illustrated in FIG. 3) and a state of being located closer to the cylinder 4 than the injection port 6 (state illustrated in FIG. 4). In the state illustrated in FIG. 3, the boss 8 is positioned between the injection port 6 and the mixing room 21, and the space between the injection port 6 and the mixing room 21 is closed. This state can be referred to as a closed state. In the closed state, even if the material to be kneaded in the mixing room 21 enters the rod guide 3, it is possible to prevent the material to be kneaded from reaching the injection port 6.

In the state illustrated in FIG. 4, since the boss 8 is farther from the mixing room 21 than the injection port 6, the injection port 6 and the mixing room 21 communicate with each other. This state can be referred to as a communication state. In the communication state, the liquid injected from the injection port 6 can flow into the mixing room 21.

As illustrated in FIG. 4, the position of the boss 8 is set so as to be in the communication state when the rod 7 is at the open position (the position where the degassing port 10 is exposed), but the present invention is not limited thereto. When the rod 7 is at the open position, the position of the boss 8 may be set so as to be in the closed state. That is, even when the degassing port 10 is exposed, the position of the boss 8 may be set such that the space between the injection port 6 and the mixing room 21 is closed by the boss 8. In this case, even when degassing is performed, the material to be kneaded can be prevented from reaching the injection port 6.

In the present embodiment, the exhausting device 12 is provided on each of the endplates 23A and 23B on both sides. Therefore, while degassing from the degassing port 10 can be performed in one exhausting device 12, liquid can be injected from the injection port 6 in the other exhausting device 12.

In the internal mixer 50 of the present embodiment having the configuration described above, the material of the material to be kneaded is fed from the material input portion 27 into the mixing chamber 25 with the weight 28 at the retraction position. After the material of the material to be kneaded is fed, the weight 28 moves to the lower position and enters the upper opening 21a of the mixing chamber 25, so that the upper opening 21a of the mixing room 21 is substantially closed. When the pair of mixing rotors 20 is driven in this state, the material to be kneaded is kneaded in the mixing room 21.

During kneading, a large amount of gas may be generated from the material to be kneaded. However, the exhausting device 12 is provided in the mixing chamber 25 such that the inner end 12a faces the inner surface of the mixing room 21. Therefore, the gas in the mixing room 21 can be discharged to the outside of the mixing chamber 25 by the exhausting device 12. Therefore, even when kneading a material to be kneaded in which a large amount of gas is generated from the material to be kneaded, an increase in the internal pressure of the mixing room 21 can be suppressed, so that such a material to be kneaded can also be kneaded.

When the weight 28 is at the lower position, a gap is formed between the inner peripheral edge of the upper opening 21a in the mixing room 21 and the outer peripheral surface of the weight 28. Therefore, the gas generated from the material to be kneaded can be discharged from the mixing room 21 to the inner space 27a of the material input portion 27 through the gap. At this time, if the amount of gas generated from the material to be kneaded is small, only discharge of the gas through the gap may be sufficient. However, in a case where a large amount of gas is generated from the material to be kneaded, only discharging the gas from the gap is not enough to prevent an increase in the pressure in the mixing room 21. Thus, the degassing by the exhausting device 12 can suppress an increase in the internal pressure of the mixing room 21.

In the present embodiment, the exhausting device 12 is provided on each of the endplates 23A and 23B on both sides, and the inner end 12a of the exhausting device 12 is located in the adjacent area AS of the mixing room 21. In the mixing room 21, the material to be kneaded flows in the mixing area MS as the mixing rotor 20 rotates, but the material to be kneaded is unlikely to enter the adjacent area AS. Therefore, the possibility that the material to be kneaded in flow comes into contact with the inner end 12a of the exhausting device 12 is reduced. Therefore, it is possible to reduce entry of a part of the material to be kneaded into the exhausting device 12. Therefore, even if the exhausting device 12 is provided in the mixing chamber 25, the exhausting device 12 is less likely to be clogged by the material to be kneaded.

In addition, degassing can be uniformly performed from both sides in the axial direction of the rotor shafts 22A and 22B. Even in a case where one exhausting device 12 is clogged, degassing can be performed from the other exhausting device 12.

In the present embodiment, the inner end 12a of the exhausting device 12 is located in a space located above the mixing rotor 20 in the adjacent area AS. Thus, the inner end 12a of the exhausting device 12 is less likely to come into contact with the material to be kneaded, so that it is possible to further reduce the possibility that the material to be kneaded gets stuck in the exhausting device 12 as the vaporized component is discharged during degassing by the exhausting device 12. Therefore, this configuration is more suitable for degassing.

In the present embodiment, since the exhausting device 12 includes the rod 7 capable of opening and closing the degassing port 10 and the cylinder 4 that moves the rod 7, the degassing port 10 can be covered with the rod 7 in a case where active degassing is unnecessary. Thus, the rod 7 can suppress clogging of the space in the rod guide 3. At the time of degassing, the degassing port 10 is exposed (opened) by the rod 7, so that degassing from the peripheral surface of the rod guide 3 can be efficiently performed.

In a case where the rod 7 is in the closed position, the rod 7 is positioned at a position where the distal end surface of the rod 7 is aligned with the inner surfaces 23c and 23d of the endplates 23A and 23B. Thus, even in a case where the rod 7 is driven by the cylinder 4 to slide to the closed position, the rod 7 does not protrude into the mixing area MS. Therefore, the rod 7 does not interfere with the pair of mixing rotors 20.

In addition, in the present embodiment, the boss 8 is provided in the intermediate portion of the rod 7, and the space in the rod guide 3 can selectively take the closed state and the communication state by the movement of the boss 8. In the closed state where the boss 8 is located closer to the mixing room 21 than the injection port 6, the injection port 6 can be prevented from being blocked by the material to be kneaded in the mixing room 21. In addition, liquid such as oil injected through the injection port 6 can spread in the rod guide 3 by the movement of the boss 8 accompanying the movement of the rod 7. On the other hand, in the case of the communication state where the boss 8 is located on the cylinder 4 side with respect to the injection port 6, it is possible to discharge an object clogged in the space in the rod guide 3 into the mixing room 21 by injecting the liquid. In addition, in a case where it is necessary to supply a liquid at the time of kneading, the liquid can be supplied to the mixing room 21 through the exhausting device 12. In addition, since it is not necessary to provide an injection mechanism on the endplates 23A and 23B separately from the exhausting device 12, it is possible to prevent an increase in the number of processing steps of the endplates 23A and 23B.

It should be understood that the embodiment disclosed herein is illustrative in all respects and is not restrictive. The present invention is not limited to the above embodiment, and various changes, improvements, and the like can be made without departing from the gist of the present invention.

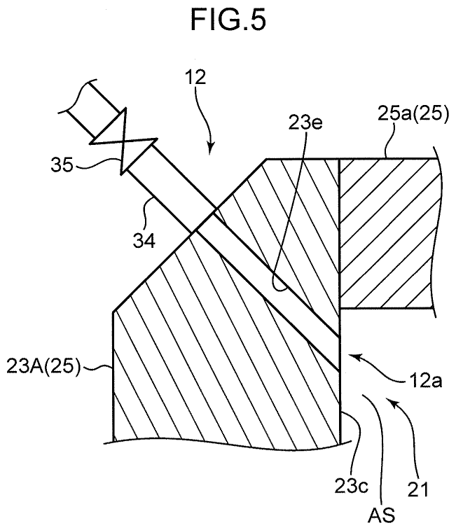

In the above embodiment, the exhausting device 12 includes the rod guide 3 provided with the degassing port 10, the rod 7 arranged in the rod guide 3, and the cylinder 4 that moves the rod 7, and is configured to open and close the degassing port 10 by the forward and backward movement of the rod 7, but the present invention is not limited thereto. For example, as illustrated in FIG. 5, the exhausting device 12 may include a through hole 23e formed in each of the endplates 23A and 23B, an external pipe 34 connected to each of the endplates 23A and 23B so as to be connected to the through hole 23e, and an on-off valve 35 provided in the external pipe 34. In this configuration, the degassing function by the through hole 23e is turned on and off by the opening and closing operation of the on-off valve 35. In this case, if the inner end 12a of the exhausting device 12 is located in the adjacent area AS in the mixing room 21, the material to be kneaded can be prevented from entering the through hole 23e.

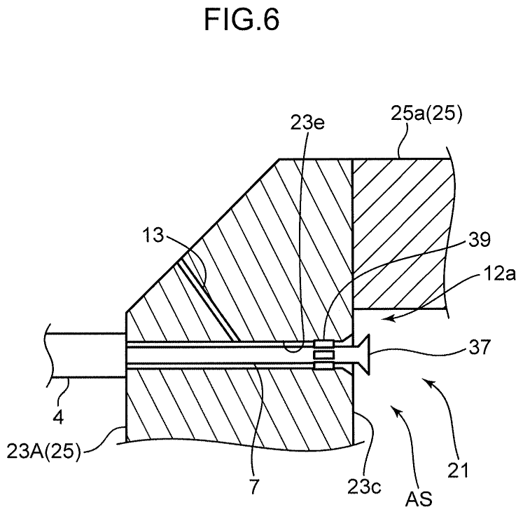

As illustrated in FIG. 6, the exhausting device 12 may include a rod 7 disposed in a through hole 23e formed in each of the endplates 23A and 23B (mixing chamber 25), and a cylinder 4 that moves the rod 7 forward and backward, and a lid member 37 that opens and closes an inner end portion of the through hole 23e may be provided at a distal end of the rod 7. In this configuration, even when a gap is formed between the outer peripheral surface of the rod 7 and the inner peripheral surface of the through hole 23e, the through hole 23e is closed by seating of the lid member 37 on the inner end portion of the through hole 23e. A exhaust passage 13 branches from the through hole 23e, and a gas in the mixing room 21 is discharged to the outside of the mixing chamber 25 through the through hole 23e and the exhaust passage 13 when the lid member 37 separates from the inner surfaces 23c and 23d of the endplates 23A and 23B (mixing chamber 25).

In this case, the inner end portion of the through hole 23e may be formed to spread, and the lid member 37 may be configured to come into surface contact with the inner end portion of the through hole 23e. The lid member 37 may be configured not to protrude from the inner surfaces 23c and 23d of the endplates 23A and 23B (mixing chamber 25) when seated on the inner end portion of the through hole 23e.

Further, in the configuration in which the lid member 37 is provided, a positioning mechanism 39 of the rod 7 may be added. The positioning mechanism 39 is disposed between the outer peripheral surface of the rod 7 and the inner peripheral surface of the through hole 23e to prevent the rod 7 from moving in the radial direction. A clearance between the rod 7 and the rod guide 3 formed by the positioning mechanism 39 functions as an exhaust path. Furthermore, in a case where a rotation preventing mechanism (not illustrated) of the rod 7 is added to the cylinder 4 to prevent the rotation of the rod 7, it is not necessary to form the shapes of the inner end portions of the lid member 37 and the through hole 23e to have circular cross sections. For example, even in a case where the inner end portions of the lid member 37 and the through hole 23e are each formed in an elliptical shape (or a shape other than a circular shape), the lid member 37 can be placed along the inner end portion of the through hole 23e. Accordingly, even in a case where the inner end portions of the lid member 37 and the through hole 23e have a shape other than the circular cross section, it is possible to prevent the lid member 37 from protruding from the inner surfaces 23c and 23d of the endplates 23A and 23B (mixing chamber 25) toward the mixing room 21 side due to the rotation of the rod 7 about the axis. As a result, it is possible to prevent the kneading material from accumulating around the lid member 37, and it is possible to avoid a situation in which the through hole 23e is blocked by the kneading material accumulating around the lid member 37 and an exhaust failure occurs.

In the above embodiment, the injection port 6 is provided in the rod guide 3, but the present embodiment is not limited thereto. That is, the injection port 6 may be provided so as to penetrate the endplates 23A and 23B (mixing chamber 25) separately from the through hole 23e in which the rod guide 3 is disposed.

In the above embodiment, the exhausting device 12 is provided in each of the pair of endplates 23A and 23B, but the present invention is not limited thereto. The exhausting device 12 may be provided only on one of the endplates 23A and 23B.

In the above embodiment, the exhausting device 12 is provided in each of the endplates 23A and 23B, but the present embodiment is not limited thereto. That is, the exhausting device 12 may be provided in the chamber body 25a of the mixing chamber 25. Even in this case, the inner end 12a of the exhausting device 12 faces the mixing room 21. In this case, the inner end 12a of the exhausting device 12 is preferably located in the adjacent area AS and faces the adjacent area AS. That is, in a case where the exhausting device 12 is provided in the chamber body 25a, the exhausting device 12 is preferably provided in a portion on the outer side in the axial direction than the pair of mixing rotors 20 in the chamber body 25a.

Here, the embodiments will be outlined.

The internal mixer according to the embodiment may include: a mixing chamber having a mixing room with an upper opening; a material input portion located above the mixing chamber, having an inner space communicating with the mixing room, and configured to be able to feed a material of a material to be kneaded into the inner space; a weight provided in the inner space; a driving device configured to move the weight up and down between a lower position and a retraction position, the lower position being a position where the weight enters the mixing room and is capable of pressing the material to be kneaded in the mixing room from above, and the retraction position being a position where the weight retreats from the lower position to open the mixing room; a pair of mixing rotors configured to knead the material to be kneaded in the mixing room; and an exhausting device having an inner end portion facing the mixing room and provided in the mixing chamber, the exhausting device being configured to discharge gas generated during kneading of the material to be kneaded from the inner end portion to an outside of the mixing chamber.

In the internal mixer, the material to be kneaded is fed from the material input portion into the mixing chamber with the weight at the retraction position. After the material is fed, the weight moves to the lower position and enters the upper opening of the mixing room. When the pair of mixing rotors is driven in this state, the material to be kneaded is kneaded in the mixing room. During kneading, a large amount of gas may be generated from the material to be kneaded. However, the exhausting device is provided in the mixing chamber such that the inner end portion of the exhausting device faces the mixing room. Therefore, the gas in the mixing room can be discharged to the outside of the mixing chamber by the exhausting device. Therefore, even when kneading a material to be kneaded in which a large amount of gas is generated from the material to be kneaded, an increase in the internal pressure of the mixing room can be suppressed, so that such a material to be kneaded can also be kneaded.

When the weight is at the lower position, a gap may be formed between the weight and the peripheral edge of the upper opening of the mixing room so that the gas generated from the material to be kneaded can be discharged from the mixing room to the inner space of the material input portion. In this case, if the amount of gas generated from the material to be kneaded is small, only discharge of the gas through the gap may be sufficient. However, in a case where a large amount of gas is generated from the material to be kneaded, discharging the gas from the gap is not enough to prevent an increase in the pressure in the mixing room. Thus, the degassing by the exhausting device can suppress an increase in the internal pressure of the mixing room.

The mixing chamber may include a cylindrical chamber body having the upper opening, and a pair of endplates that closes openings at both ends of the chamber body. In this case, the exhausting device may be provided on at least one of the pair of endplates. The mixing room may have a mixing area at a position corresponding to the pair of mixing rotors and an adjacent area at a position axially shifted from the mixing area. The inner end portion of the exhausting device may face the adjacent area.

In this aspect, the exhausting device is provided on at least one endplate, and the inner end portion of the exhausting device is located in the adjacent area of the mixing room. In the mixing room, the material to be kneaded flows in the mixing area as the mixing rotor rotates, but the material to be kneaded is less likely to enter the adjacent area. Therefore, there is a low possibility that the material to be kneaded in flow comes into contact with the inner end portion of the exhausting device. Therefore, a part of the material to be kneaded can be reduced from entering the exhausting device, so that even if the exhausting device is provided in the mixing chamber, the exhausting device is less likely to be clogged by the material to be kneaded.

The inner end portion of the exhausting device may be located in a space located above the pair of mixing rotors in the adjacent area.

In this aspect, the inner end portion of the exhausting device is less likely to come into contact with the material to be kneaded. Therefore, at the time of degassing by the exhausting device, the possibility that the material to be kneaded is clogged in the exhausting device along with the discharge of the vaporized component can be further reduced. Therefore, this configuration is more suitable for degassing.

The exhausting device may be provided in each of the pair of endplates.

In this aspect, the exhausting device is provided on both endplates, and the inner end portion of the exhausting device is located in an adjacent area in the mixing room. In the mixing room, the material to be kneaded flows in the mixing area as the mixing rotor rotates. At this time, there is a low possibility that the material to be kneaded enters the adjacent area. Therefore, there is a low possibility that the material to be kneaded in flow comes into contact with the inner end portion of the exhausting device. Therefore, it is possible to reduce entry of a part of the material to be kneaded into the exhausting device. Therefore, even if the exhausting device is provided in the mixing chamber, the exhausting device is less likely to be clogged by the material to be kneaded at the time of degassing by the exhausting device. In addition, degassing can be uniformly performed from both sides in the axial direction. Even in a case where one exhausting device is clogged, degassing can be performed from the other exhausting device.

The exhausting device may include a cylindrical rod guide inserted into a through hole formed in at least one of the pair of endplates, a rod disposed in the rod guide, a degassing port provided in the rod guide, an exhaust passage provided in at least one of the pair of endplates so as to communicate with the degassing port, and a cylinder that moves the rod so as to expose or cover the degassing port by the rod. In this case, the inner end portion of the rod guide may constitute the inner end portion of the exhausting device located in the adjacent area.

In this aspect, since the degassing port can be covered with the rod in a case where active degassing is unnecessary, clogging of the space in the rod guide can be suppressed. In a case where the active degassing is necessary, the degassing port is exposed by moving the rod, so that degassing from the peripheral surface of the rod guide can be performed.

In a case where the rod is at a closed position for covering the degassing port, a distal end surface of the rod may be aligned with the inner end portion, and in a case where the rod is at an open position for exposing the degassing port, the distal end surface of the rod may be located in the rod guide.

A boss may be provided in an intermediate portion of the rod so as to be in contact with the rod guide. In the rod guide, an injection port for injecting liquid may be provided on the cylinder side with respect to the degassing port. In this case, the cylinder may be configured to move the rod so that the boss can take a state of being located closer to the mixing room than the injection port and a state of being located closer to the cylinder than the injection port.

In this aspect, in the state where the boss is located closer to the mixing room than the injection port, the injection port can be prevented from being blocked by the material to be kneaded in the mixing room. In addition, liquid such as oil injected through the injection port can spread in the rod guide by the movement of the boss accompanying the movement of the rod. In addition, in the case of the state where the boss is located on the cylinder side with respect to the injection port, it is possible to discharge an object clogged in the space in the rod guide into the mixing room by injecting the liquid. In addition, in a case where it is necessary to supply a liquid at the time of kneading, the liquid can be supplied to the mixing room through the exhausting device. In addition, since it is not necessary to provide an injection mechanism on the endplates separately from the exhausting device, it is possible to prevent an increase in the number of processing steps of the endplates.

The mixing chamber may include a cylindrical chamber body having the upper opening, and a pair of endplates that closes openings at both ends of the chamber body. In this case, the exhausting device may include a through hole formed in at least one of the pair of endplates and including an inner end portion functioning as the inner end portion of the exhausting device, a rod inserted into the through hole, an exhaust passage provided in the at least one of the pair of endplates so as to branch from the through hole, and a cylinder configured to move the rod. In this case, when the distal end surface of the rod closes the inner end portion of the through hole, the distal end surface of the rod may be aligned with the inner surface of the mixing chamber facing the mixing room.

In this aspect, the inner end portion of the through hole is closed by the distal end surface of the rod, so that the material to be kneaded can be prevented from entering the through hole and clogging the through hole. When the distal end surface of the rod closes the inner end portion of the through hole, the rod can be prevented from interfering with the kneading of the material to be kneaded.

When the distal end surface of the rod is in a state of opening the inner end portion of the through hole, the distal end surface may be located in the through hole.

The mixing chamber may include a cylindrical chamber body having the upper opening and a pair of endplates that closes the openings at both ends of the chamber body, and the mixing room may include a mixing area at a position corresponding to the pair of mixing rotors and an adjacent area at a position axially shifted from the mixing area. In this case, the exhausting device may be provided in the chamber body such that the inner end portion of the exhausting device faces the adjacent area.

In this aspect, the exhausting device is provided in the chamber body such that the inner end portion of the exhausting device faces the adjacent area. In the mixing room, the material to be kneaded flows in the mixing area as the mixing rotor rotates. At this time, there is a low possibility that the material to be kneaded enters the adjacent area. Therefore, the possibility that the material to be kneaded in flow comes into contact with the inner end portion of the exhausting device is reduced. Therefore, a part of the material to be kneaded can be reduced from entering the exhausting device, so that even if the exhausting device is provided in the mixing chamber, the exhausting device is less likely to be clogged by the material to be kneaded.

As described above, a material to be kneaded in which a large amount of gas such as steam is generated can be kneaded.

This application is based on U.S. Provisional application No. 63/707,506 filed in United States Patent and Trademark Office on October. 15, 2024, the contents of which are hereby incorporated by reference.

1. An internal mixer comprising:
a mixing chamber having a mixing room with an upper opening;
a material input portion located above the mixing chamber, having an inner space communicating with the mixing room, and configured to be able to feed a material of a material to be kneaded into the inner space;
a weight provided in the inner space;
a driving device configured to move the weight up and down between a lower position and a retraction position, the lower position being a position where the weight enters the mixing room and is capable of pressing the material to be kneaded in the mixing room from above, and the retraction position being a position where the weight retreats from the lower position to open the mixing room;
a pair of mixing rotors configured to knead the material to be kneaded in the mixing room; and
an exhausting device having an inner end portion facing the mixing room and provided in the mixing chamber, the exhausting device being configured to discharge gas generated during kneading of the material to be kneaded from the inner end portion to an outside of the mixing chamber.

2. The internal mixer according to claim 1, wherein
the mixing chamber includes a cylindrical chamber body having the upper opening and a pair of endplates that closes openings at both ends of the chamber body,
the exhausting device is provided on at least one of the pair of endplates,
the mixing room includes a mixing area at a position corresponding to the pair of mixing rotors and an adjacent area at a position axially shifted from the mixing area, and
the inner end portion of the exhausting device faces the adjacent area.

3. The internal mixer according to claim 2, wherein the inner end portion of the exhausting device is located in a space located above the pair of mixing rotors in the adjacent area.

4. The internal mixer according to claim 2, wherein the exhausting device is provided in each of the pair of endplates.

5. The internal mixer according to claim 2, wherein
the exhausting device includes a cylindrical rod guide inserted into a through hole formed in at least one of the pair of endplates, a rod disposed in the rod guide, a degassing port provided in the rod guide, an exhaust passage provided in at least one of the pair of endplates so as to communicate with the degassing port, and a cylinder that moves the rod so as to expose or cover the degassing port by the rod, and
an inner end portion of the rod guide constitutes the inner end portion of the exhausting device located in the adjacent area.

6. The internal mixer according to claim 5, wherein,
in a case where the rod is at a closed position for covering the degassing port, a distal end surface of the rod is aligned with the inner end portion, and
in a case where the rod is at an open position for exposing the degassing port, the distal end surface of the rod is located in the rod guide.

7. The internal mixer according to claim 5, wherein
a boss is provided in an intermediate portion of the rod so as to be in contact with the rod guide,
an injection port for injecting a liquid is provided in the rod guide on the cylinder side with respect to the degassing port, and
the cylinder is configured to move the rod such that the boss can take a state of being located closer to the mixing room than the injection port and a state of being located closer to the cylinder than the injection port.

8. The internal mixer according to claim 1, wherein
the mixing chamber includes a cylindrical chamber body having the upper opening and a pair of endplates that closes openings at both ends of the chamber body,
the exhausting device includes a through hole formed in at least one of the pair of endplates and including an inner end portion functioning as the inner end portion of the exhausting device, a rod inserted into the through hole, an exhaust passage provided in the at least one of the pair of endplates so as to branch from the through hole, and a cylinder configured to move the rod, and
when a distal end surface of the rod closes the inner end portion of the through hole, the distal end surface of the rod is aligned with an inner surface of the mixing chamber facing the mixing room.

9. The internal mixer according to claim 8, wherein,
when a distal end surface of the rod is in a state of opening the inner end portion of the through hole, the distal end surface is located in the through hole.

10. The internal mixer according to claim 1, wherein
the mixing chamber includes a cylindrical chamber body having the upper opening and a pair of endplates that closes openings at both ends of the chamber body,
the mixing room includes a mixing area at a position corresponding to the pair of mixing rotors and an adjacent area at a position axially shifted from the mixing area, and
the exhausting device is provided in the chamber body such that the inner end portion of the exhausting device faces the adjacent area.
